(19) United States
(12) Patent Application Publication
(10) Pub. No.: US 2013/0084535 A1
(43) Pub. Date: Apr. 4, 2013

(54) MULTI-COLORED, MULTI-SCENTED CANDLE

(71) Applicants: Norbert A. Braun, Singapore (SG); Tee Yong Tan, Singapore (SG); Klaus Christian Meyer, melle (DE)

(72) Inventors: Norbert A. Braun, Singapore (SG); Tee Yong Tan, Singapore (SG); Klaus Christian Meyer, melle (DE)

(73) Assignee: SYMRISE AG, HOLZMINDEN (DE)

(21) Appl. No.: 13/637,078

(22) PCT Filed: Mar. 26, 2010
(86) PCT No.: PCT/EP10/54044

§ 371 Date: Dec. 5, 2012

(51) Int. Cl. C11C 5/00; C11C 5/02

(52) U.S. Cl. CPC C11C 5/002; C11C 5/008; C11C 5/023
USPC 431/288; 431/2; 264/257

(57) ABSTRACT

The invention relates to a multi-colored, multi-scented candle, comprising a solidified block of fuel and a wick embedded therein, wherein the solidified block of fuel comprises two, three or more distinct fuel members strung on the wick and partially or completely embedded in the outer fuel portion of the solidified block of fuel, wherein a first member and a second member of said distinct fuel members are adjacent and have different scents and different colors.

Further described is a process for producing such a candle. The invention also relates to the use of a candle for conveying a multi-color and/or multi-scent experience to and to a corresponding method.

The invention relates to a multi-colored, multi-scented candle, comprising a solidified block of fuel and a wick embedded therein, wherein the solidified block of fuel comprises two, three or more distinct fuel members strung on the wick and partially or completely embedded in the outer fuel portion of the solidified block of fuel, wherein a first member and a second member of said distinct fuel members are adjacent and have different scents and different colors.

Further described is a process for producing such a candle. The invention also relates to the use of a candle for conveying a multi-color and/or multi-scent experience and to a corresponding method.

Perfuming candles is an art with a long history. Evolution of this art has seen the candle from its humble, functional form to the colorful, decorative formats of today.

US 2008/0070174 discloses layered pillar candles having (removable) tea-light candles. It also discloses candles having a filler core of solidified wax (which may be colored and/or scented) and several annular layers of wax (e.g. three color-scent varieties) which each are molten and brought into contact with the filler core such that it is fused to the filler core. The differently colored and/or scented wax rings are not strung on a wick, nor does a candle according to US 2008/0070174 allow a separate or sequential perception the different scents. In particular, all scents are perceivable when smelling on the surface of a candle according to US 2008/0070174.

U.S. Pat. No. 6,203,313 proposes a candle comprising a least two different stacked wax members, each wax member having a through-hole defined therein and a wick strung through the through-holes of said wax members.

U.S. Pat. No. 6,079,975 teaches a multi-layer candle with each layer having a different fragrance which will blend with one another as the candle burns, creating a new and different aroma. U.S. Pat. No. 6,079,975 inter alia describes the manufacturing of a three-layer candle wherein a fragranced first candle portion is obtained from a mold and is subsequently placed in a second larger mold which is then filled with molten candle material that has a second fragrance. Then the two layer candle is removed from the mold and inserted into a third larger mold into which a third molten candle material is inserted which has a third fragrance.

US 2008/0081305 discloses a candle having two distinct regions visible from the top, said regions may have different scents or different colors. US 2008/0081305 further discloses that one method of making a candle includes a first step of creating a solid inner portion or core containing a candle wick. Molten fuel that will form the outer portion/bulk phase is then poured into a container of a suitable size. The solid core containing the wick is then inserted into the container containing the molten bulk phase.

US 2007/0169405 discloses a scented jar candle that includes at least two different wax materials with one such wax material having one melting point and at least one of the other wax materials having a second melting point. A candle in accordance with US 2007/0169405 may be manufactured by pouring the lower melting wax material into a jar. While said wax material is still liquid, the candle core of the wax having the higher melting point is inserted in a central position in the candle. US 2007/0169405 does not disclose to candles having more than two different fuel regions, nor to a candle having more than two different scents.

US 2007/0003895 relates to a candle having multiple scents in a single candle. In particular, the candle includes multiple inner segments, which melt simultaneously during burning of the candle. Each of the inner segments includes a different scent so that burning of the candle blends the scents together and provides a new combined scent. The candle according to US 2007/0003895 may be formed by first forming the individual inner segments of a wax having a higher melting temperature and placing these inner portions within a mold in a predetermined arrangement and thereafter pouring into the mold a wax of a lower melting temperature. The wick is disposed between the inner segments. The inner segments are divided by the outer portion such that the inner segments are kept spaced apart. The inner segments may be all be of the same color or may be of mutually different colors and the outer portion may be of the same color as one or more of the inner components or of a different color.

The object of the present invention is to provide a candle conveying or imparting a multi sensory experience, preferably in a sequential (consecutive) manner. In particular, said candle should during use thereof, i.e. during burning, convey multiple, preferably at least three, different scent impressions consecutively and at least two, preferably three or more, different visual, in particular color, impressions in conjunction with said scent impressions. Such a candle should thus predominantly provide one scent and visual impression at a time. A change of scent should be accompanied by pronounced visible changes, preferably in color and optionally further visual signals. Preferably, primarily or solely one scent (scent type) should be olfactory perceivable on the outer surface of the candle and not a mixture of different scents.

The present invention relates to a multi-colored, multi-scented candle, comprising a solidified block of fuel and a wick embedded therein,

wherein the solidified block of fuel comprises an outer fuel portion and two, three or more distinct fuel members strung on the wick and partially or completely embedded in the outer fuel portion,
wherein
a first member of said distinct fuel members has a first scent and a first color, and
a second member of said distinct fuel members has a second scent and a second color,
wherein said first and second member are adjacent, said first and second scents are different and said first and second colors are different.

A candle in accordance with the present invention conveys multiple consecutive scent impressions and at least two different visual, in particular color, impressions in conjunction with said scent impressions.

The outer fuel portion of the solidified block of fuel defines the outer shape of the candle.

Preferably, the outer fuel portion of the solidified block of fuel of a candle in accordance with the present invention has a scent which is different from said first scent and from said second scent. Such a candle conveys at least three different scent impressions.

In a candle according to the present invention preferably the solidified block of fuel comprises two, three or more distinct fuel members strung on the wick which are completely embedded in the outer fuel portion of the solidified block of fuel. Such a candle conveys at least three different scent impressions sequentially during burning of said candle. The mixing of scents during burning of a candle according to the present invention is largely or substantially avoided.

While it can be said that a mixing of scents of the outer fuel portion and of a distinct fuel member is inevitable, such mixing only occurs to such an extent during the burn phase of the candle, that the olfactive character of the scent in the distinct fuel member is strongly expressed, thereby giving a distinct transition of scents in the burn phase of a candle of the present invention. The distinct fuel members individually and sequentially positioned on the wick are of importance to ensure that the scents in these distinct fuel members are strongly presented during the burn phase in a sequential manner.

Preferably, no two immediately adjacent distinct fuel members contain the same scent and preferably no two immediately adjacent distinct fuel members contain the same color.

In preferred embodiments, candles according to the present invention comprise
a third distinct fuel member which has a third scent and a third color, said third scent being different from said first and second scents and said third color being different from said first and second colors, and
optionally a fourth distinct fuel member which has a fourth scent and a fourth color, said fourth scent being different from said first, second and third scents and said fourth color being different from said first, second and third colors, and
optionally a fifth distinct fuel member which has a fifth scent and a fifth color, said fifth scent being different from said first, second, third and fourth scents and said fifth color being different from said first, second, third and fourth colors and
   wherein preferably the outer fuel portion of the solidified block of fuel has a scent which is different from said third scent and, if present, from said fourth and fifth scents.

Such a candle imparts three, four, five, six or more different scent impressions consecutively.

A candle according to the present invention preferably is free of non-scented fuel members, in particular free of non-scented wax seals.

In a preferred candle according to the present invention one, two or all of the distinct fuel members have a through-hole and are strung through said through-holes on the wick.

The distinct fuel members in the present invention are not limited in size or shape and may be strung on the wick in a continuous or non-continuous manner (i.e. the members may be abutting or be spaced apart).

The distinct fuel members may take the shape of animals, sea creatures (fish, starfish, sea shells, crabs), vegetables, fruits (apples, lemons, orange slices, pineapples and the like), flowers, hearts, sun, moon, stars, geometric forms (cubes, cylinders, pyramids, cones etc.) and the like.

If the wick is strung through the through-holes of the wax members, the distinct fuel members may be laterally movable with respect to each other in a direction (at least substantially) perpendicular to the wick when the distinct fuel members are stacked on the wick. More preferably the wick is sized to be closely received within the through-holes of the distinct fuel members.

In a further preferred embodiment, in a candle according to the present invention at least two or more of the distinct fuel members are secured to the wick, preferably such that adjacent faces of adjacent distinct fuel members are spaced apart (i.e. not abutting). More preferably the distinct fuel members are secured to the wick such that the distinct fuel members are not movable along the wick, preferably the distinct fuel members are fused to the wick.

The wick preferably extends substantially vertically, preferably vertically, through the candle and/or is preferably centered in the candle.

Preferably, the wick (via through-holes or not) is centrally oriented in the distinct fuel members with respect to the axis of the wick.

If distinct fuel members are spaced apart, preferably the distance between each of the distinct fuel members is in the range of from 1 mm to 20 mm, preferably 2 mm or more, more preferably 3 mm or more, even more preferably 4 mm or more. In some preferred embodiments the distance between each of the distinct fuel members is in the range of from 4 mm to 10 mm.

The distinct fuel members of a candle in accordance with the present invention can preferably be obtained by casting the liquefied or molten composition of the distinct fuel members into molds of the desired form or by pressing the composition of the distinct fuel members into molds of the desired form by using processes known in the art.

Wicks common to candle making can be used in the present invention. A wide variety of wicks are suitable for candles of the present invention. Wicks suitable for various candles according to the present invention can be obtained from companies such as Heinz Verhaegh Corporation.

Technical aspects on burn properties related to wick usage can be obtained from Heinz Verhaegh Corporation and is included in the appendix as reference literature.

The wick may optionally be coated with a wax so as to stiffen the wick thereby allowing for easier placement of the wick in the desired position during the candle manufacturing process. Coating the wick with wax will also help fill in any air pockets which to may be present in the wick thereby allowing for more even burning of the wick.

Coating the wick or priming the wick is of relevance particularly for jar candles. In a pillar candle, the melt-pool may overflow off the sides of the candle and the wick is still held strongly in an upright position by the part of the candle still remaining as a solid. In a jar candle, the melt-pool remains and depending on the height or depth of the melt-pool, the exposed wick may bend excessively in the melt-pool and drown itself, thereby extinguishing the flame. Therefore, the wax coating on the wick is usually of a higher melting-point than the temperature of the melt-pool. This requirement helps the wick to maintain its upright position in the melt-pool.

In general, wicks can be divided into the following major types:

Flat Wicks. These flat-plaited or knitted wicks, usually made from three bundles of fiber, are very consistent in their burning and curl in the flame for a self-trimming effect. They are the most commonly used wicks, and can be broadly found in taper and pillar candles.

Square Wicks. These braided or knitted wicks also curl in the flame, but are more rounded and a bit more robust than flat wicks. They are preferred for beeswax applications and can help inhibit clogging of the wick, which can occur with certain types of pigments or fragrances. Square wicks are most frequently used in taper and pillar applications.

Cored Wicks. These braided or knitted wicks use a core material to keep the wick straight or upright while burning. The wicks have a round cross section, and the use of different core materials provides a range of stiffness effects. The most common core materials for wicks are cotton, paper, zinc or tin. Cored wicks can be found in jar candles, pillars, votives and devotional lights.

In contrast to layered candles of the prior art where each colored layer has an individual fragrance that can be olfactively perceived from the surface, the present invention allows for an additional fragrance in the outer fuel portion as well as individual fragrance for each distinct fuel member.

One particular aspect of the present invention relates to the dye diffusion from the distinct fuel members while limiting its extent of fragrance release from influencing the olfactive character of the fragrance in the outer fuel portion. By controlling the process conditions, dye diffusion occurs in a controlled manner such that dye diffusion from the distinct fuel members takes place while limiting its extent of fragrance release from influencing the olfactive character of the fragrance in the outer fuel portion.

The term “dye diffusion” as used herein is not to be understood in the strict physicochemical sense. “Dye diffusion” as used herein relates to dye transport phenomena whereby the dye moves from an area of higher dye concentration to an area of lower dye concentration. In this context, the term “diffusion” thus also includes convection phenomena.

The present invention allows to produce color effects on the surface of a candle without undue influence on the fragrance of the outer fuel portion. Preferably, as the outer fuel portion is cast over the distinct fuel members, the resultant candle has a consistent finish on the surface with only the fragrance of the outer fuel portion olfactory perceivable from the surface.

The amount of dye diffusing and migrating into the outer fuel portion is inter alia limited by the period of time before the outer fuel portion solidifies as the temperature falls below its melting temperature. While it is reasonable to assume that a certain amount of fragrance is also extracted at this transitional moment, it does not constitute an amount enough to alter the olfactive character of the fragrance in the outer fuel portion. This result can be achieved when controlling the composition and process parameters, as described in more detail below.

The majority of fragrance diffusion in a candle is largely based on the principle of consumption that is, as the wax is melted down in the burning phase, capillary action denotes that the fragrance is released with the molten wax and drawn up the burning wick into its immediate surroundings.

The present invention does not require specially designed candle molds and the multi-colored, multi-scented candles of the present invention are not limited in shape or size. Thus, the candles of the present invention can also have the shape of cones, to spheres, cubes, eggs and the like.

The present invention in one aspect also relates to a multi-colored, multi-scented candle whereby the layers of colors on the finished candle are formed in a single casting operation with varying colored-tones to each layer. When the melt-pool is formed in the burn phase, the shape of the distinct fuel members can be perceived thereby adding a visual element to the experience for the consumer.

In another aspect, the present invention relates to producing candles having a layered appearance on the outer surface of the outer fuel portion displaying strong and soft tones of colors whereby the layered appearance is formed in a single casting operation which represents a significant time reduction in the final candle molding process. In order for the colorants to manifest on the outer surface of the candle, the colorants are used in sufficient amount and via dye diffusion to a limited extent reach the surface of the finished candle before complete solidification of the molten phase of the outer fuel portion.

The present invention offers a simple, economical method to obtain multi-colored, multi-scented candles without the need for specially designed molds and processing steps. The resultant candle can have a layered appearance or a fusion of the colors on the surface of the candle.

As used herein, “member”, “portion” or “segment” refers to an area or region wherein at least one attribute differs between the members, portions or segments.

A candle according to the present invention comprises at least two, preferably three or more, different scents. A scent can be a single fragrance material or a mixture thereof (perfumes, perfume oils, essential oils). Perfumes used in the present invention can be selected from the large palette of perfumes available for creative perfumery work.

As used herein, the terms “fragrance”, “scent”, and “perfume” are used interchangeably to refer to odoriferous material that is included in the candle fuel and released into the atmosphere/surroundings.

In preferred embodiments the total amount of fragrance materials in the outer fuel portion and in each distinct fuel member in a candle of the present invention is in the range of from 0.1 to 20% by weight, preferably in the range of from 0.5 to 10% by weight, based on the total weight of the outer fuel portion or the respective fuel member.

Suitable fragrance materials are mentioned in S. Arctander, Perfume and Flavor Chemicals, Vol. I and II, Montclair, N.J., 1969, self-published or H. Surburg and J. Panten, Common Fragrance and Flavor Materials, 5th. Ed., Wiley-VCH, Weinheim 2006, particularly those explicitly mentioned in US 2008/0070825.

Preferred extracts from natural raw materials such as essential oils, concretes and absolutes and resinoids are selected from the group consisting of: amyris oil; angelica seed oil; angelica root oil; aniseed oil; valerian oil; basil oil; tree moss absolute; bay oil; armoise oil; benzoe resinoid; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute; cedar leaf oil; cedar wood oil; cistus oil; citronella oil; lemon oil; copaiba balsam oil; coriander oil; costus root oil; cumin oil; cypress oil; davana oil; dill weed oil; dill seed oil; eau de brouts absolute; oak moss absolute; elemi oil; estragon oil; eucalyptus citriodora oil; eucalyptus oil; fennel oil; fir needle oil; galbanum oil; galbanum resin; geranium oil; grapefruit oil; guaiacwood oil; gurjun balsam oil; helichrysum absolute; helichrysum oil; ginger oil; iris root absolute; iris root oil; jasmine absolute; calamus oil; blue camomile oil; Roman camomile oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemon-grass oil; lovage oil; lime oil distilled; lime oil expressed; linaloe oil; Litsea cubeba oil; laurel leaf oil; mace oil; marjoram oil; mandarin oil; massoi (bark) oil; mimosa absolute; ambrette seed oil; clary sage oil; nutmeg oil; myrrh absolute; myrrh oil; myrtle oil; clove leaf oil; clove bud oil; neroli oil; olibanum absolute; olibanum oil; opopanax oil; orange flower absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil; spike-lavender oil; star anise oil; storax oil; tagetes to oil; fir needle oil; tea tree oil; turpentine oil; thyme oil; tonka bean absolute; tuberose absolute; vanilla extract; violet leaf absolute; verbena oil; vetiver oil; juniperberry oil; wine lees oil; wormwood oil; wintergreen oil; ylang-ylang oil; hyssop oil; civet absolute; cinnamon leaf oil and cinnamon bark oil.

In a preferred embodiment a candle according to the invention comprises one or more carriers acceptable for perfumery, said carriers preferably are selected from the group consisting of diethyl phthalate, triethyl citrate, isopropyl myristate and/or benzyl benzoate.

The carriers are preferably used in an amount to the fragrance composition in order to aid dispersion in the fuel, in particular the wax(es), of the outer fuel portion and the respective distinct fuel members. Preferably, the weight ratio of total weight of the fragrance carriers and the total amount of fragrance materials is in the range of from 1:10 to 10:1, preferably in the range of from 1:5 to 5:1, more preferably in the range of from 1:3 to 3:1.

In another preferred embodiment a candle according to the present invention comprises one or more fragrance materials having a Clog P value of at least 3, preferably of at least 4, more preferably of at least 5.

More preferably, a candle according to the present invention comprises at least one, two, three, four, five, six, seven, eight or more of the fragrance materials selected from the group consisting of (here in some cases the normal industrial product names and registered trademarks of various firms are given):

alpha-hexylcinnamaldehyde, 2-phenoxyethylisobutyrate (Phenirat), dihydromyrcenol (2,6-dimethyl-7-octen-2-ol), methyl dihydrojasmonate (preferably with a content of cis-isomers of >60 by weight (Hedione, Hedione HC), 4,6,6,7,8,8-hexamethyl-1,3,4,6,7,8-hexahydrocyclopenta[g]benzopyran (Galaxolid), tetrahydrolinalool (3,7-dimethyloctan-3-ol), ethyllinalool, benzylsalicylate, 2-methyl-3-(4-tert-butylphenyl)propanal (Lilial), cinnamon alcohol, 4,7-methano-3a,4,5,6,7,7a-hexahydro-5-indenyl acetate and/or 4,7-methano-3a,4,5,6,7,7a-hexahydro-6-indenyl acetate (Herbaflorat), styrolyl acetate (1-phenylethyl acetate), octahydro-2,3,8,8-tetramethyl-2-acetonaphthone and/or 2-acetyl-1,2,3,4,6,7,8-octahydro-2,3,8,8-tetramethylnaphthaline (Iso E Super), hexyl salicylate, 4-tert.-butylcyclohexyl acetate (Oryclon), 2-tert.-butylcyclohexyl acetate, alpha-ionone (4-(2,2,6-trimethyl-2-cyclohexen-1-yl)-3-buten-2-one), coumarin, terpinyl acetate, 4-(4-hydroxy-4-methylpentyl)-3-cyclohexene carboxaldehyde (Lyral), alpha-amyl cinnamon aldehyde, (E)- and/or (Z)-3-methylcyclopentadec-5-enone (Muscenone), 15-pentadec-11-enolide and/or 15-pentadec-12-enolide (Globalide), 15-cyclopentadecanolide (Macrolide), 1-(5,6,7,8-tetrahydro-3,5,5,6,8,8-hexamethyl-2-naphthalenyl)ethanone (Tonalide), 2-isobutyl-4-methyltetrahydro-2H-pyran-4-ol (Florol), 2-ethyl-4-(2,2,3-trimethyl-3-cyclopenten-1-yl)-2-buten-1-ol (Sandolen), menthol (preferably l-menthol or racemic menthol, with particular preference for l-menthol), anethole, geraniol, nerol, linalool, citronellol, citronellal, hydroxycitronellal, linalyl acetate, 2-phenylethyl alcohol, 2,2-dimethyl-3-(3-methylphenyl)-propanol (Majantol), rose oxide (4-methyl-2-(2-methyl-1-propenyl)tetrahydropyran), allyl heptanoate, 4-methylacetophenone, Timberol (1-(2,2,6-trimethylcyclohexyl)hexan-3-ol), Floropal (2,4,6-trimethyl-4-phenyl-1,3-dioxan), benzylacetone, methyl cinnamate, 3a,6,6,9a-tetramethyldodecahydronaphtho[2,1-b]furan (Ambroxid), benzyl acetate, melonal, menthone, isomenthone, amyl acteate, isoamyl acetate, cis-hexenol, cis-hexenyl acetate, hexyl acetate, isoamyl butyrate, butyl butyrate, eucalyptol, helional, ethylene brassylate, 2,6-nonadienol.

The total amount of fragrance materials selected from the above group, preferably having a boiling point of 250° C. or greater at 1013 mbar, preferably is at least 10 wt. %, more preferably at least 20 wt. %, based on the total amount of fragrance materials present in a composition or product according to the present invention.

Fragrances common to air freshener applications, preferably designed for candles, such as the Maxessences™ fragrances (Symrise) are considered particularly suitable for the present invention.

The manufacturing and compositions of candle fragrances are described in U.S. Pat. No. 7,288,515, its content hereby incorporated herein by reference in its entirety.

Preferably, the weight ratio of the total mass of the outer fuel portion to the total mass of the distinct fuel members is in the range of from 20:1 to 1:2, more preferably in the range of from 15:1 to 1:1, even more preferably in the range of from 10:1 to 2:1, most preferably in the range of from 8:1 to 3:1. If the total mass of the distinct to fuel members is too small, the multi-sensory experience is not pronounced enough. If the total mass of the outer fuel portion is too small, a mixing of scents and/or colors in an undesired extent, in particular during manufacturing of the candle, may occur. In addition, it may be that on the outer surface of the candle more than one scent is perceivable due to an insufficient thickness of the outer fuel portion relative to the surface of the distinct fuel members.

Generally, all waxes (natural or synthetic) common to candle-making are suitable in the context of the present invention.

According to the present invention candles are preferred, wherein each distinct fuel member comprises one or more waxes having a melting point in the range of from 45 to 80° C., preferably in the range of from 50 to 70° C., more preferably in the range of from 50 to 65° C., preferably in a total amount in the range of from 60 to 98% by weight, more preferably in the range of from 65 to 95% by weight, even more preferably in the range of from 70 to 90% by weight, based on the total weight of the respective fuel member.

According to the present invention candles are preferred, wherein the outer fuel portion comprises one or more waxes having a melting point in the range of from 45 to 80° C., preferably in the range of from 50 to 70° C., more preferably in the range of from 50 to 65° C., preferably in a total amount in the range of from 60 to 98% by weight, more preferably in the range of from 65 to 95% by weight, even more preferably in the range of from 70 to 90% by weight, based on the total weight of the outer fuel portion.

Preferred waxes are selected from the group consisting of paraffin wax, stearin wax, microcrystalline wax, carnauba wax, beeswax, palm wax, soy wax, spermaceti wax, ozokerite wax and mixtures thereof.

Commercial blends of paraffin or candle waxes can also be used in the invention. Suitable grades can be obtained from suppliers such as Reed Wax. Natural waxes such as palm wax can be obtained from suppliers such as Megasuryamas (Indonesia) or Lipidchem (Malaysia).

In a preferred embodiment, two or more different waxes are employed, wherein preferably ozokerite is one of the waxes.

Ozokerite is particularly useful in pillar candles according to the present invention as it increases the hardness (of the waxes) of a candle, allows better (easier) demolding of the candle and it also modifies the burn rate of the candle and the flame behaviour during burning of the candle. Ozokerite in particular enables easier demolding of the candle particularly when the main component of the outer fuel portion are paraffin waxes.

Thus, in a preferred embodiment, the candle according to the present invention is a pillar candle wherein the outer fuel portion (and optionally one, two or more of the distinct fuel members) comprise ozokerite, preferably ozokerite and one or more paraffin waxes.

In jar candles, waxes commonly have a lower melting point and a tendency to adhere or stick to the walls of the jar. In this respect, the “sticky property” is a positive and desired attribute of the waxes for a jar candle.

Candle additives can generally be used as wax crystal modifiers, to help control the melting temperature, hardness, shrinkage, gloss, and opacity of the fuel of the candle, in particular in combination with the wax(es) mentioned above. For example, wax crystal modifiers generally can be used to help bind fragrance to the fuel, in particular the wax(es), so as to prevent bleed of the fragrance from the wax.

Candle additives are ingredients preferably included in the fuel of a candle usually in comparatively small amounts to give some added functional benefits. In the cases of polyethylene waxes and poly-alpha-olefin, it can be said that they help to bind the fragrances to the candle composition especially if the dosage of the fragrances is more than 3% whereby sweating or droplets of oils may form on the surface of the candle at room temperature. Candle additives are not considered to act as the main fuel source for both economical and practical reasons.

Preferred candle additives according preferably included in a candle according to the present invention are selected from the group consisting of ethyl vinyl acetate, petrolatum, polyethylene waxes, poly-alpha-olefins (alpha-olefin polymers and copolymers; such as Vybar 103, Vybar 260 (Baker Petrolite)), fatty acids (preferably C12-C18 saturated carboxylic acids, preferably selected from the group consisting of lauric, myristic, palmitic and/or stearic acid) and mixtures thereof.

In the case of polyethylene waxes and poly-alpha-olefin having a higher melt point than the main fuel sources, they are useful in aiding a consistent flame or burn rate. Paraffin waxes regardless of their melt points are more mobile up the wick in the liquid state via capillary action. Therefore, a candle made entirely of paraffin wax burns faster than a candle made of paraffin wax with a combination of other waxes and candle additives.

In the context of the present invention candle additives are preferably included in a candle according to the present invention, but not necessarily present in all cases.

According to the present invention candles are preferred, wherein each distinct fuel member contains an additive selected from the group consisting of ethyl vinyl acetate, petrolatum, polyethylene waxes, poly(α-olefins), fatty acids (preferably C12-C18 saturated carboxylic acids, more preferably selected from the group consisting of lauric, myristic, palmitic and/or stearic acid) and mixtures thereof, preferably in the range of from 0.5 to 20% by weight, more preferably in the range of from 1 to 10% by weight, based on the total weight of the respective fuel member.

According to the present invention candles are preferred, wherein the outer fuel portion contains an additive selected from the group consisting of ethyl vinyl acetate, petrolatum, polyethylene waxes, poly(α-olefins), fatty acids (preferably C12-C18 saturated carboxylic acids, more preferably selected from the group consisting of lauric, myristic, palmitic and/or stearic acid) and mixtures thereof, preferably in the range of from 0.5 to 20% by weight, more preferably in the range of from 1 to 10% by weight, based on the total weight of the outer fuel portion.

Poly-alpha-olefins are preferably used in a candle in accordance with the present invention to increase the amount of fragrances included into the candle mass (higher fragrance amount, avoids/reduces migration of fragrance materials to the outer candle surface, “sweating”), poly-alpha-olefins also add gloss to the candle.

In a preferred embodiment, the outer fuel portion and each of the distinct fuel members in a candle according to the present invention contain the same fuel(s), preferably the same wax(es), more preferably the outer fuel portion and the distinct fuel members have the same fuel composition, in particular the same wax composition. Although the usage of waxes of differing compositions can be effectively incorporated into the present invention, one advantage of using waxes of the same composition is maintaining consistency of flame behavior in the burn phase.

In another preferred embodiment of a candle according to the present invention, the outer fuel portion in the solid state conceals the three dimensional shape of at least one of said distinct fuel members, wherein the outer fuel portion and said at least one, preferably two, three or more, of said distinct fuel members are adapted to each other such that during burning of the candle a molten pool is formed by the outer fuel portion above said distinct fuel member such that the three dimensional shape of said distinct fuel member is exposed.

Thus, during burning of a candle according to the present invention preferably the outer fuel portion and one or more of the distinct fuel members are visibly distinct from the top and from the side through the melt-pool of the burning candle (“3Deffect”). Preferably, due to the difference in melting temperatures of the outer fuel portion and the one or more of the distinct fuel members, the three dimensional shape of one, two, three or more of said distinct fuel members becomes visible in form of a relief, namely a bas-relief (low relief).

This 3D-effect is particularly well perceivable from a perspective view, in particular from an 45° angle relative to the axis along wick, preferably when burning said candle such that a pool of molten fuel from the outer fuel portion is formed across the whole cross-section of the candle, said pool of molten fuel preferably having a height of 5 mm, more preferably of 10 mm, and said pool of molten fuel contacting, preferably exposing the full cross-section of at least one distinct fuel member.

In another preferred embodiment of a candle according to the present invention, the melting temperature of the outer fuel portion is lower, preferably 3 to 6° C. lower, than the melting temperature of the fuel of each of the distinct fuel members. The above mentioned “3D-effect” is particularly pronounced when using fuels, in particular waxes, having a difference in melting temperatures in the indicated range.

If fuels or waxes are used which have a melting range, the melting points of the fuels or waxes used are calculated as weighted average melting points. For example, if a fuel composition consisting of 90 wt. % of fuel having a melting point (m.p.) of 58° C. and 10 wt. % of a fuel having m.p. 60° C., the weighted average melting point is 58.2° C. If a wax having a m.p. range of 52-55° C. is used, said wax is considered to have a calculated average melting point of 53.5° C.

In another preferred embodiment, a candle according to the present invention, on the outer surface of the candle essentially, preferably solely, the scent of the outer fuel portion is perceived.

In another preferred embodiment of a candle according to the present invention one, two or more of the colors of the distinct fuel member(s) are visually perceivable on the surface of the candle, preferably such that the candle has a marbled (marmorate) appearance.

In a preferred candle of the present invention only one scent is olfactory perceivable on the outer surface of the candle while the scents associated with the respective distinct fuel members are perceivable only during burning of the candle. This is particularly effectively achieved if the distinct fuel members in a candle according to the present invention are fully embedded by the outer fuel portion by casting said outer fuel portion, i.e. pouring the liquefied or molten outer fuel portion onto and around the distinct fuel members such that the distinct fuel members are completely embedded.

The liquefied or molten outer fuel portion is preferably cast (poured) over the distinct fuel members when having a temperature not higher than 30° C., preferably in the range of from 5 to 30° C., more preferably in the range of from 10 to 30° C., most preferably in the range of from 10° C.-20° C., above the melting point of the outer fuel portion.

Preferably, the liquefied or molten outer fuel portion is preferably cast (poured) over the distinct fuel members when having a temperature not higher than 30° C., preferably in the range of from 5 to 30° C., more preferably in the range of from 10 to 30° C., most preferably in the range of from 10° C.-20° C., above the melting point of the distinct fuel members.

The casting temperature is important. If the outer fuel portion is cast at just above its melting point, for example about 2-3° C. above its melting point, the molten fuel will harden in a very short time upon casting into the mould and there mostly will not be sufficient time for the colors from the distinct fuel members to diffuse to the outer surface of the candle to an extent desired in accordance with one of the preferred embodiments of the present invention. If the outer fuel portion is cast at just above its melting point, it may also be that the distinct fuel member will not be fully embedded by the outer fuel portion or the outer fuel portion may not have a sufficient thickness as desired in accordance with one of the preferred embodiments of the present invention.

At above 30° C. of the melting point of the outer fuel portion, there is a longer time for the fuel mass to harden by cooling to room temperature. This extended period of time allows the outer surfaces of the distinct fuel members to melt to a noticeable extent. In the example of the distinct fuel member in the shape of a starfish given below, the most vulnerable areas of the starfish are the pointed edges of its arms. Once these pointed edges melt away, the shape of the starfish (i.e. outlines and/or three dimensional shape) is adversely affected. When the melt-pool is formed in the burning phase of the candle, the shape of the starfish would not be sufficiently visibly distinct. This adverse influence on the shape of the distinct fuel members in accordance with one of the preferred embodiments of the present invention should be minimized, i.e. largely or fully avoided.

In another preferred embodiment of a candle according to the present invention, the thickness of the outer fuel portion on all sides of the distinct fuel members is at least 2 mm, preferably at least 3 mm, more preferably in the range of from 4 to 20 mm, even more preferably in the range of from 4 to 10 mm.

In another preferred embodiment of a candle according to the present invention, in any part of the candle the shortest distance between the distinct fuel members and the outer surface of the outer fuel portion is at least 2 mm, preferably at least 3 mm, more preferably in the range of from 4 to 20 mm, even more preferably in the range of from 4 to 10 mm.

Thus, the distance between the outer surface of the distinct fuel members and the inner wall of the candle mold or the inner diameter of the jar is at least 2 mm, preferably at least 3 mm, more preferably in the range of from 4 to 20 mm, even more preferably in the range of from 4 to 10 mm.

In a particularly preferred embodiment the present invention relates to a multicolored, multi-scented candle, comprising a solidified block of fuel and a wick embedded therein, wherein the solidified block of fuel comprises an outer fuel portion and two, three or more distinct fuel members strung on the wick completely embedded in the outer fuel portion, wherein

a first member of said distinct fuel members has a first scent and a first color, and
a second member of said distinct fuel members has a second scent and a second color,
the outer fuel portion of the solidified block of fuel has a scent which is different from said first scent and from said second scent,
wherein the outer fuel portion and each distinct fuel member comprise one or more waxes having a melting point in the range of from 50 to 65° C. in an amount of 65 to 95% by weight, based on the total weight of the respective fuel member,
and
wherein the total amount of fragrance materials in the outer fuel portion and in each distinct fuel member in a candle of the present invention is in the range of from 0.5 to 10% by weight, based on the total weight of the outer fuel portion or the respective fuel member,
said outer fuel portion and each distinct fuel member preferably additionally comprising one or more carriers selected from the group consisting of diethyl phthalate and/or isopropyl myristate,
and
wherein the thickness of the outer fuel portion on all sides of the distinct fuel members is in the range of from 4 to 20 mm, preferably in the range of from 4 to 10 mm.

Oil-dispersible and oil-soluble dyes are preferred in the context of the present invention.

Preferably a candle according to the present invention comprises a total amount of colorants in each distinct fuel member in the range of from 0.001 to 0.5% by weight, preferably in the range of from 0.002 to 0.1% by weight, more preferably in the range of from 0.005 to 0.01% by weight, based on the total weight of the respective fuel member.

Suitable grades can be obtained from Clariant under the Fat series, for example Fat Brown, Fat Blue, Fat Yellow and the like.

Dyes and pigments are among the colorants that may be used in the solid, colored, shaped wax-based article of the present invention. Fluorescent colorants can also be used as colorants in the present invention. Particular preference is given to oil soluble dyes.

The additive is a colorant such as oil-soluble dyes and pigments that create desired color. Suitable pigments include titanium dioxide and zinc oxide white; copper, bronze, and aluminum metal powders and flakes; and phthalocyanine blue, phthalocyanine green, and yellow and red pigments of the benzimidazolone group such as Pigment Yellow 180 and Pigment Red 208 for colors. For a comprehensive disclosure of pigments and soluble dyes with sufficient thermal stability for use in plastics and therefore also in combustible candle compositions according to this invention, reference can be made to Chapter 63-Organic Colored Pigments (pages 884 899) and Chapter 65-Colors, Dyes (pages 913 919) in “Plastics Additives and Modifiers Handbook”, J. Edenbaum (ed.), Van Nostrand Reinhold, N.Y. 1992, herein incorporated by reference. The additives are all commercially available.

Preferred are oil soluble dyes as colorants in the context of the present invention and are preferably selected from the group consisting of: C. I. Solvent Yellow 3, C.I. Solvent Green 3, C. I. Acid Black 429, C. I. Solvent Red 207, C. I. Phthalo Blue, C. I. Solvent Violet 13, C.I. Disperse Violet 17, C.I. Solvent Yellow 14, C.I. Solvent Blue 36, C.I. Solvent Yellow 33, C.I. Solvent Red 149, C. I. Solvent Yellow 56, C. I. Solvent Yellow 90, C. I. Solvent Red 26, Solvent Red 3, Solvent Red 27, C. I. Solvent Yellow 29, Solvent Red 24, C.I. Solvent Yellow 16, C.I. Solvent Yellow 72, C.I. Solvent Blue 104, C. I. Solvent Yellow 93, C. I. Solvent Yellow 98, C. I. Disperse Yellow 64, C.I. Solvent Yellow 24, C. I. Solvent Orange 60, C. I. Vat Red 41, C.I. Solvent Red 195, C. I. Solvent Red 111, C. I. solvent Red 179, C. I. Solvent Red 135, C. I. Solvent Red 63, C. I. Disperse Violet 26, C. I. Solvent violet 37, C.I. Solvent Green 28, C. I. Solvent Yellow 133, C. I. Solvent Yellow 164, Solvent Blue 35, C. I. Solvent Blue 122, C. I. Solvent Violet 49, C. I. Solvent Brown 122, C.I. Solvent Red 91, C.I. Solvent Red 164, and C. I. Solvent Blue 98.

The thermal degradation is a concern primarily during manufacturing processes where a candle fuel is held for extended period of time at or above the melting temperature of said fuel. Antioxidants and UV absorbers are often added to the candle fuel as stabilizers in order to avoid (photo)degradation, deterioration and/or discoloration, in particular during manufacturing and during storage of the candle. In addition, scented candles may suffer from undesired changes of the scent characteristics during manufacturing and during burning of the candle, owing to exposure to heat and/or light.

Suitable UV absorbers are, for example, organic UV absorbers from the class comprising 4-aminobenzoic acid and derivatives, salicylic acid derivatives, benzophenone derivatives, dibenzoylmethane derivatives, diphenyl acrylates, 3-imidazol-4-yl acrylic acid and esters thereof, benzofuran derivatives, benzylidene malonate derivatives, polymeric UV absorbers containing one or more organosilicon radicals, cinnamic acid derivatives, camphor derivatives, trianilino-s-triazine derivatives, 2-hydroxyphenylbenzotriazole derivatives, phenylbenzimidazole sulfonic acid derivatives and salts thereof, anthranilic acid menthyl esters, benzotriazole derivatives, indole derivatives.

Further suitable UV absorbers in the context of the present invention including the benzophenone derivatives, benzotriazole derivatives, benzoate esters, phenyl salicylates, derivatives of crotonic acid, malonic acid esters, and cyanoacrylates are described in U.S. Pat. No. 4,260,732 and U.S. Pat. No. 4,404,257 as well as the piperidine compounds disclosed in U.S. Pat. No. 5,439,958 and the UV absorbers described in WO 2000/022037.

When used, UV absorbers are preferably added at a level of from about 0.01% to about 0.5% by weight of the wax. For instance, it may be desirable to add an UV (“ultraviolet stabilizer”) to help protect colorants from UV degradation.

Suitable antioxidants are described in U.S. Pat. No. 7,220,288 and the prior art cited therein.

Preferred antioxidants are tert.-butylhydroquinone, n-octadecyl 3,5-di-tert-butyl-4-hydroxyhydrocinnamate, butylated hydroxyanisole, phenol bisphosphite, butylated hydroxytoluene, and phosphite compounds. The antioxidants are all commercially available. Preferably, the total amount of (one or more) antioxidants in a candle according to the present invention is in the range of from 0.015% to 2.5% by weight, more preferably in the range of from 0.1 to 0.75% by weight and most preferably in the range of from 0.2 to 0.5% by weight, in each case based on the total weight of the candle.

In addition to the fragrance materials, the outer fuel portion and/or one, two or more of the distinct fuel members may comprise further volatile materials.

It is also possible to include volatile malodor counteracting substances or volatile odor neutralizing materials, e.g. malodor combating fragrance materials or odor neutralizing fragrance materials, into a candle of the present invention.

Further, it is also possible to include insect repellents into a candle according to the present invention.

Preferably, a candle according to the present invention is a pillar candle or a container candle.

The candle of the instant invention may also be placed in a container. The container may be any container suitable for holding a candle. The container may be comprised of any number of different materials including but not limited to polymers having a melting point greater than about 100° C. (including but not limited to polyethylene terephthalate, polycarbonate, and polymethyl methacrylate); and preferably glass; metal; ceramic; or a combination thereof. The candle container may be of any size or shape.

In a preferred embodiment, the container is made of a transparent material, preferably a transparent (optionally colored), more preferably clear, glass or polymer.

The (particularly) preferred aspects and embodiments mentioned hereinbefore or hereinafter relating to candles according to the present invention are preferably combined with other (particularly) preferred aspects and embodiments mentioned hereinbefore or hereinafter relating to candles according to the present invention.

The (particularly) preferred aspects and embodiments mentioned hereinbefore or hereinafter relating to candles according to the present invention also apply to (particularly) preferred uses and methods in accordance with the present invention.

The present invention is not limited by the specialized candle molds, common equipment for various forms of candle making can be used. Apart from standalone candles, the present invention can also be used in container candles.

A candle according to the present invention can be cast without the use of specially-designed molds and is non-limited in shape or size.

The present invention also relates to a process for manufacturing a candle, preferably in accordance with one or more (preferred) embodiments indicated for preferred candles according to the present invention, comprising the following steps:
(a) providing
a wick,
two, three or more distinct fuel members, wherein a first member and a second member of said distinct fuel members have different scents and different colors, and
an outer fuel portion in liquefied or molten state,
(b) stringing said distinct fuel members on the wick such that a first member and a second member of said distinct fuel members are adjacent, preferably such that the distinct fuel members are centered around the wick,
(c) placing the distinct fuel members strung on the wick into a mold or a container,
(d) casting said outer fuel portion, preferably at a temperature in the range of from 5 to 30° C., more preferably in the range of from 10 to 30° C., most preferably in the range of from 10 to 20° C., above the melting temperature of said outer fuel portion, such that the outer fuel portion partially, preferably completely, embeds the two, three or more distinct fuel members strung on the wick,
(e) solidifying of the outer fuel portion in the mold or container, and
(f) removing the candle from the mold, if a mold was used.

The liquefied or molten outer fuel portion is preferably cast (poured) over the distinct fuel members when having a temperature not higher than 30° C., most preferably in the range of 10° C.-20° C., above the melting point of the outer fuel portion. In this temperature range of the outer fuel portion the best dye diffusion results in a candle according to the present invention were obtained. Casting the outer fuel portion in said preferred temperature range yield the best dye diffusion effects and color effects on the finished candle in the sense that excessive deformation of the distinct fuel member is avoided, thereby ensuring that the outlines (contours) and the three dimensional shape of the respective distinct fuel member is visually distinct and well perceived during the burn phase of the candle.

Preferably, the liquefied or molten outer fuel portion is preferably cast (poured) over the distinct fuel members when having a temperature not higher than 30° C., preferably in the range of 10° C.-20° C., above the melting point of the distinct fuel members.

Preferably, in a process according to the present invention the distinct fuel members strung on the wick in step (c) are arranged in the mold or container such that the shortest distance between the distinct fuel members and the outer surface of the outer fuel portion is at least 2 mm, preferably at least 3 mm, more preferably in the range of from 4 to 20 mm, even more preferably in the range of from 4 to 10 mm.

The present invention also relates to a candle obtainable or obtained according to a process according to the present invention.

The present invention also relates to the use of a candle according to the present invention to convey (impart) a multi-color and/or multi-scent experience.

The present invention also relates to a process for conveying (imparting) a multi-color and multi-scent experience, comprising the following steps:
burning a candle according to the present invention,
preferably such that a pool of molten fuel of the outer fuel portion forms across the whole cross-section of the candle,
more preferably burning said candle continuously for 30 minutes or more, preferably one hour or more, preferably three hours or more.

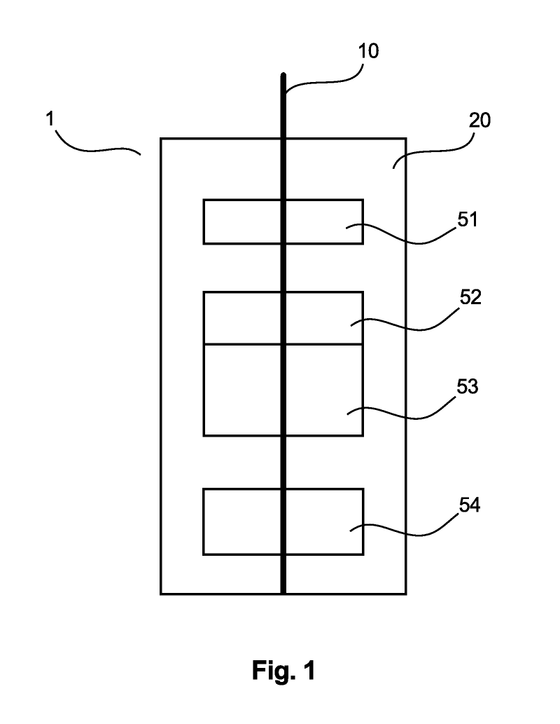

The invention will now be explained in more detail with reference to the accompanying FIGS. 1 to 3, in which

FIG. 1 is a diagrammatic cross-sectional view of a non-limiting example of a multi-colored, multi-scented candle according to the present invention;

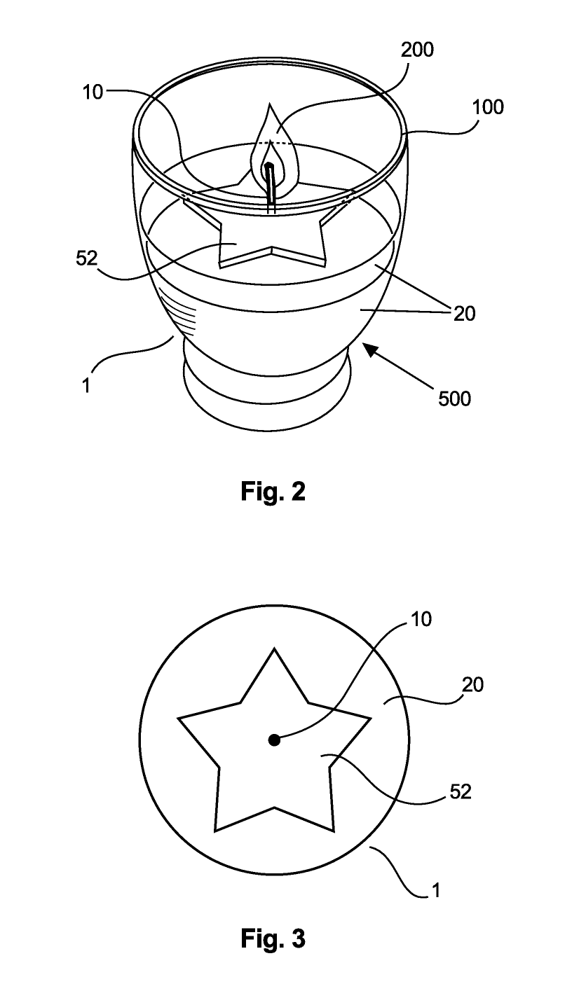

FIG. 2 is a diagrammatic perspective view of another non-limiting example of a multi-colored, multi-scented candle according to the present invention;

FIG. 3 is a diagrammatic top plan view of another non-limiting example of a multi-colored, multi-scented candle according to the present invention.

With reference to FIG. 1, a multi-colored, multi-scented candle 1 is provided having a wick 10. The candle 1 comprises an outer fuel portion 20 and four distinct fuel members 51, 52, 53 and 54. The candle 1 in one embodiment was produced as a pillar candle and in another embodiment as a container candle.

In one embodiment, the first member (51) of said distinct fuel members has a first scent (rose), a first color (red) and a first shape (flower), the second member (52) of said distinct fuel members has a second scent (seabreeze), a second color (orange) and a second shape (starfish), the third member (53) of said distinct fuel members has a third scent (lemon-lime), a third color (green-yellow) and a third shape (lemon) and the fourth member (54) of said distinct fuel members has a fourth scent (blueberry), a fourth color (blue) and a fourth shape (cylindrical shape). The outer fuel portion 20 did not comprise any colorant (i.e. the outer fuel portion 20 thus had an opaque whitish appearance due to the paraffin wax used) and had a fifth scent (lavender).

In FIG. 1 all distinct fuel members are secured to wick 10. While the distinct fuel members 51 and 54 are spaced apart with respect to the adjacent faces of adjacent distinct fuel members 52 and 53 respectively. In contrast thereto, the adjacent distinct fuel members 52 and 53 are strung on the wick 10 in a continuous manner with respect to their mutual adjacent faces.

FIG. 1 also shows that the four distinct fuel members 51, 52, 53 and 54 are fully surrounded by the outer fuel portion 20 and that the height (thickness) of the four distinct fuel members 51, 52, 53 and 54 along the axis of the wick may vary. In the embodiment in FIG. 1, distinct fuel member 51 has the smallest height whereas distinct fuel member 53 has the largest height of the four distinct fuel members.

When wick 10 is lit, the burn phase of the candle 1 begins. During the burn phase, the outer fuel portion 20 and the subsequently the distinct fuel members (51, 52, 53, 54) will melt and burn.

With reference to FIG. 2, a container candle 500 is provided comprising a container material 100 and a multi-colored, multi-scented candle 1 according to the present invention. Said candle 1 comprises a wick 10, a distinct fuel member 52 and an outer fuel portion 20. The container 100 is a clear glass jar.

In FIG. 2, the wick 10 is lit by a flame 200 which caused the outer fuel portion 20 to partially melt, thereby forming a pool of molten (liquid) fuel of the topmost outer fuel portion 20 across the whole cross-section of the candle. While the topmost fuel portion 20 is in a liquid state, the lower part of the outer fuel portion 20 is still solid. Thus, during burning of candle 1 the outer fuel portion 20 and the distinct fuel member 52 are visibly distinct through a melt-pool of the outer fuel portion 20 of the burning candle (“3D-effect”). Due to the difference in melting temperatures of the outer fuel portion 20 and the distinct fuel member 52, the three dimensional shape, in the present case the shape of a five-pointed star, of distinct fuel member 52 becomes visible in form of a relief.

For the sake of clarity it should be mentioned that a further distinct fuel member 53 is secured to wick 10 and placed near the bottom of the container 100. Since distinct fuel member 53 is fully embedded by the solid outer fuel portion 20 and the molten pool of the outer fuel portion 20 has not reached the upper surface of distinct fuel member 53 (yet), from the perspective view in FIG. 2 said distinct fuel member 53 is not visible.

The top view shown in FIG. 3 corresponds to the candle in FIG. 2 just after the flame has been extinguished. FIG. 3 shows a multi-colored, multi-scented candle 1 having a wick 10. The outlines of the distinct fuel member 52 are clearly and distinctly visible through the pool of the liquid outer fuel portion 20 still extending across the whole cross-section of the candle.

Preferred embodiments and further aspects of the present invention emerge from the attached patent claims and the following examples.

The examples describe the invention in more detail, without limiting the area of protection of the claims. Unless stated otherwise, all the data, in particular amounts and percentages, relate to the weight.

In the following examples, flat-braided cotton wicks were used for the standalone/pillar candles while Stabilo series wicks from Heinz Verhaegh Corporation were used for the container (jar) candles.

In the examples, solution of oil-soluble dyes were used. As solvents diethyl phthalate, isopropyl myristate, paraffin oil or liquid mineral oil were used.

### EXAMPLE 1

In this experiment, distinct fuel members having a diameter of 5 cm are held together non-continuously by the wick running through the centre of the candle mold. The candle mold has an inner diameter of 6 cm and is cylindrical in shape.

A first candle is cast at a temperature of 70° C.-80° C. and a second candle is cast at a temperature of 80° C.-90° C. The uncolored outer fuel portion is melted to the temperature of 70° C.-80° C. for the first candle and 80° C.-90° C. for the second candle. The molten outer fuel portion is then poured into the respective candle mold until it completely covers the distinct fuel members. Once the candle has completely solidified, it is removed from the candle mold.

The finished candle cast at 80° C.-90° C. showed a stronger color tone for the layers of color than the candle cast at 70° C.-80° C. Both candles showed a varying tone in colors (blue, green and red) for the layers giving the appearance of a multi-layer candle with strong and soft tones in color. This demonstrated that at higher temperature more pronounced dye diffusion from the distinct fuel members takes place. Also due to the longer duration for the molten mass of the outer fuel portion to solidify meant that the dye extracted has more time to diffuse to the surface of the candle.

The wax composition of distinct fuel members was the same as the outer fuel portion.

While it is appreciated that a higher casting temperature gives a stronger color presence on the finished candle, there is a tendency for the colors to fuse and form secondary colors when the casting temperature exceeds 30° C. of the melting point of the waxes.

### Formulation of Distinct Fuel Members

| Ingredient | Supplier | wt. % | Remarks |
|---|---|---|---|
| Paraffin Wax (m.p. 60-62° C.) | Epichem | 84 | Part A |
| Vybar 103 (Polyalphaolefin) | Baker Petrolite | 1 | (70° C.-80° C.) |
| Stearic Acid | | 5 | |
| Ozokerite Wax | | 4 | |
| Oil-soluble dye (1% solution) | | 0.5 | Part B |
| Fragrance (Mint, Rose or Ocean) | | 5.5 | |
| Total | | 100 | |

Procedure:
1) Melt the ingredients of Part A. Mix well. (70° C.-80° C.)
2) Add the ingredients of Part B accordingly. Mix well.
3) Cast the molten mass into molds to form the distinct fuel members.
4) If the distinct fuel members are desired to be held by the wick, a hollow space through the distinct fuel member can be formed by inserting a small cylindrical rod or similar object that suits the diameter of the desired candle to wick. The hollow space created need not be centrically located in the distinct fuel member.
5) A candle wick can be threaded through the solidified colored distinct fuel members at desired space intervals if required.

### Formulation of Outer Fuel Portion

| Ingredient | Supplier | wt. % | Remarks |
|---|---|---|---|
| Paraffin Wax (m.p. 60-62° C.) | Epichem | 84 | Part A |
| Vybar 103 (Polyalphaolefin) | Baker Petrolite | 1 | (70° C.-90° C.) |
| Stearic Acid | | 5 | |
| Ozokerite Wax | | 4 | |
| Fragrance (natural Lavender oil, | | 6 | Part B |
| free of perfumery solvents) | | | |
| Total | | 100 | |

Procedure:
1) Melt the ingredients of Part A. Mix well. (70° C.-90° C.)
2) Add Part B. Mix well.
3) Cast the molten mass at the desired temperature into the candle molds containing the distinct fuel members.
4) Once the candle has solidified, it can be removed from the candle mold.

For this experiment, the molten mass of the outer fuel portion is not colored. Thereto fore the color effects on the final candle are produced through the dye diffusing from the distinct fuel members subjected to the temperature of the molten outer fuel portion mass. Both candles olfactively exhibit the character profile of the Lavender fragrance on the surface of the outer fuel portion.

The three distinct fuel members made up of two optically visible parts (e.g. a flower or a star embedded in a wax disk) are considered as three distinct fuel members, each member only contained one scent; this illustrates that each distinct fuel member may have more than one color, but only one scent (in the instant example: the first disk had a mint scent, the second disk had a rose scent and the third disk had a ocean scent (sea breeze)). The disks have the advantage that the distance between distinct fuel members and the outer diameter of the final candle (=inner diameter of the jar in case of a jar candle) is uniform resulting in an even, consistent dye diffusion effect on the outer surface of the finished candle. In this respect, the bands of color formed on the finished candle are perceived across the circumference of the finished candle, though there may be slightly stronger and softer tones of the color within the bands.

### EXAMPLE 2

In this experiment, one set of distinct fuel members has a dye dosage of 0.002% and another set has a dye dosage of 0.005%. The same wax composition as in Example 1 is used for the distinct fuel members and the outer fuel portion.

These distinct fuel members are centrically located in the candle via the candle wick and they do not touch the walls of the candle mold. The inner diameter of the candle mold is 2.3 cm. The distance between the outer surface of the distinct fuel members and the inner wall of the candle mold is 4 mm. The process parameters for the distinct fuel members and the outer fuel portion as stated in Example 1 are used and the casting temperature is set at 70° C.-80° C.

The candle with a higher dosage of dye showed a stronger intensity in the color tones as compared with the candle having a lower dosage of dye. Therefore the dosage of the dye used can be a variable in the manipulation of the color effects in the finished candle. As the candle mold used in this experiment is smaller in size to the candle mold in Example 1, the present invention demonstrated that the color effects can be reproduced in candles of different sizes.

### EXAMPLE 3

In this experiment, the smallest distance between the inner wall of the candle mold and the outer surface of the distinct fuel members is 1 cm. The formulation of the wax composition and the candle mold of Example 1 are used in this experiment.

Distinct fuel members each had a diameter of 4 cm and were in the form of a blue star, an orange-red heart and a green sun. The distinct fuel members were strung on a wick and placed in a mold having an inner diameter of 6 cm.

The resultant candle cast at 80° C.-90° C. showed a much lesser degree of dye diffusion compared with the candle prepared in Example 1. This experiment demonstrated that the distance between the inner wall of the candle mold and the outer surface of the distinct fuel members for dye diffusion has an influence on the color effects in the finished candle.

During burning of the candle, the shape of the distinct fuel member is visible in the melt-pool.

### EXAMPLE 4

In this experiment, the present invention is used in a container candle formulation.

The same palm wax composition is used for both the distinct fuel members and the outer fuel portion.

| | | Distinct | Outer | |
|---|---|---|---|---|
| | | fuel | fuel | |
| | | segments | portion | |
| Ingredient | Supplier | wt. % | wt. % | Remarks |
| Palm Wax 5401A | Lipidchem | 97 | 97 | Part A |
| (m.p. 52° C.-56° C.) | | | | (70° C.-80° C.) |
| Oil-soluble dye | | 0.5 | | Part B |
| (1% solution) | | | | |
| Perfume | Symrise | 2.5 | 3 | |
| Total | | 100 | 100 | |

Procedure:
1. Melt the ingredients of Part A. (70° C.-80° C.).
2. Add the ingredients of Part B accordingly. Mix well.
3. Transfer mixture into molds.

The distinct fuel members (three differently scented and differently colored discs each 5 cm in diameter) held with the wick are placed in the centre of the container (inner diameter 6.5 cm). The outer fuel portion base is cast over the distinct fuel members at 70° C.-80° C. and allowed to cool to room temperature.

The resultant candle showed a layered appearance with soft and strong tones of colors. This experiment showed that the present invention can be used in container candles as well as waxes (here: of natural origin).

### EXAMPLE 5

In this example, the present invention is used in a container candle formulation and the distinct fuel members are in various shapes and sizes.

| | Member | Member | Member | |
|---|---|---|---|---|
| Ingredient | A/wt. % | B/wt. % | C/wt. % | Remarks |
| Vybar 103 (Poly-alpha- | 1 | 1 | 1 | Part A |
| olefin) (Baker Petrolite) | | | | (70° C.-80° C.) |
| Ozokerite | 2 | — | 2 | |
| Stearin wax | — | 95.5 | — | |
| Paraffin wax (m.p. 58° C.) | 93.5 | — | 93.5 | |
| Oil-soluble color dye | 0.5 | 0.5 | 0.5 | Part B |
| (1% solution) | | | | |
| Blood Orange (Max- | 3 | — | — | |
| essence ™ Perfume) | | | | |
| Apple Cinnamon (Max- | — | 3 | — | |
| essence ™ Perfume) | | | | |
| Strawberry Lemon | | — | 3 | |
| (Perfume, Symrise) | | | | |
| Total | 100 | 100 | 100 | |

Member C was the lowermost member, had a red color and the shape of a strawberry, Member B had a dark-green color and the shape of a shell, Member C was the topmost member, had a orange color and the shape of a starfish. The three distinct fuel members (held with a wick are placed into jars in various combinations. A outer fuel portion base of the following formulation is then cast over the distinct fuel members.

| Ingredient | Supplier | wt. % | Remarks |
|---|---|---|---|
| SM 8382 (palm wax/ | Megasuryamas | 96 | Part A |
| low-melting paraffin, | | | (70° C.-80° C.) |
| m.p.. 52° C.-55° C.) | | | |
| Vanilla Bourbon (Perfume) | Symrise | 4 | |
| Total | | 100 | |

A glass jar having a height of 75 mm, a top inner diameter of 55 mm and a bottom inner diameter of 25 mm was used. The finished candle in the jar showed distinctive reddish dye diffusion towards the reduced diameter region.

When the candle burns, a melt-pool begins to form around the immediate area of the flame.

As the candle continues to burn, the starfish shape of the distinct fuel member becomes clearly visible.

This experiment showed that the distinct fuel members can add a visual appeal in the burn phase. As the starfish shape of the distinct fuel member is clearly visible, it demonstrated that the distinct fuel member is not unduly affected when the outer fuel portion is cast at the appropriate temperature range not exceeding 30° C. above the melting point of the outer fuel portion. The 3-D effect of the starfish distinct fuel member in the melt-pool is best exemplified by using a harder wax composition for the starfish distinct fuel member in comparison to the outer fuel portion wax composition. The difference in melting points should preferably be in the range of 3° C. to 6° C.

### EXAMPLE 6

The outer fuel portion is melted to the temperature of 70° C.-80° C. for a first candle and 80° C.-90° C. for a second candle. The outer fuel portion is then poured in molten form into the candle mold until it completely covered all the distinct fuel members placed in the respective mold. Once the candle has completely solidified, it is removed from the candle mold.

### Formulation of Distinct Fuel Members

| | Supplier | % | Remarks |
|---|---|---|---|
| Edenor ST 1 MY | Cognis | 5 | Part A |
| (Palmitic/Stearic Acid) | | | (60° C.-70° C.) |
| Ozokerite wax | | 5 | |
| Vybar 103 (Poly-alpha-olefin) | Baker Petrolite | 4 | |
| Paraffin Wax (m.p. 54° C.) | | 75 | |
| Oil-soluble dye (1% solution) | | 1 | Part B |
| Vanilla Scent(Perfume) | Symrise | 10 | |
| Total | | 100 | |

Procedure:
1) Melt the ingredients of Part A. Mix well. (60° C.-70° C.)
2) Add the ingredients of Part B accordingly. Mix well.
3) Cast the molten mass into molds to form the distinct fuel members.
4) The wax segments were held by the wick; a hollow space through the wax segment was formed by inserting a small cylindrical rod or similar object that suits the diameter of the desired candle wick. The hollow space created was to centrically located in the distinct fuel members.
5) A candle wick was threaded through the solidified distinct fuel members at desired space intervals.

### Formulation of Outer Fuel Portion

| | Supplier | % | Remarks |
|---|---|---|---|
| Edenor ST 1 MY | Cognis | 5 | Part A |
| (Palmitic/Stearic Acid) | | | (70° C.-90° C.) |
| Ozokerite wax | | 3 | |
| Vybar 103 (Poly-alpha-olefin) | Baker Petrolite | 4 | |
| Paraffin Wax (m.p. 54° C.) | | 83 | |
| Peppermint oil (Perfume) | Symrise | 5 | Part B |
| Total | | 100 | |

Procedure:
1) Melt the ingredients of Part A. Mix well. (70° C.-90° C.)
2) Add Part B. Mix well.
3) Cast the molten outer fuel portion at the desired temperature into the candle molds containing the distinct fuel members.
4) Once the candle has solidified, it can be removed from the candle mold.

For this experiment, the molten mass of the outer fuel portion was not colored. Therefore the color effects on the final candle are produced through the dye diffusing from the distinct fuel members subjected to the temperature of the molten outer fuel portion.

A first candle is cast at a temperature of 70° C.-80° C. (preferred according to the present invention) and a second candle is cast at a temperature of 80° C.-90° C. (not preferred according to the present invention).

The candle cast at 70° C.-80° C. showed strong elements of its secondary wax segments of blue, red and yellow.

The candle cast at 80° C.-90° C. showed the formation of secondary colors from the primary colors of blue, red and yellow. Elements of green, reddish-orange and yellowish-orange can be seen in the comparative regions against the candle cast at 70° C.-80° C. The higher temperature allows more dye to be released and the extended length of time needed for the candle to solidify meant the released dyes from the three secondary color segments can mix to form the secondary colors giving the candle a marbled appearance.

In this experiment, the distinct fuel members having blue, red and yellow color respectively, are held together non-continuously by the wick running through the centre of the candle mold and they do not touch the walls of the candle mold. The distinct fuel members have a diameter of 1.5 cm and the inner diameter of the candle mold is 2.3 cm. The secondary wax segments weigh a total of 6 grams and the final candle has a weight of 30 grams.

1. A multi-colored, multi-scented candle comprising a solidified block of fuel and a wick embedded therein,
wherein the solidified block of fuel comprises an outer fuel portion and two or more distinct fuel members strung on the wick and partially or completely embedded in the outer fuel portion,
wherein
a first member of said distinct fuel members has a first scent and a first color, and a second member of said distinct fuel members has a second scent and a second color,
wherein said first and second member are adjacent, said first and second scents are different and said first and second colors are different.

2. The candle according to claim 1, wherein the outer fuel portion of the solidified block of fuel has a scent which is different from said first scent and from said second scent.

3. The candle according to any of claim 1, wherein the solidified block of fuel comprises two or more distinct fuel members strung on the wick and completely embedded in the outer fuel portion of the solidified block of fuel.

4. The candle according to claim 1, comprising
a third distinct fuel member which has a third scent and a third color, said third scent being different from said first and second scents and said third color being different from said first and second colors, and
optionally a fourth distinct fuel member which has a fourth scent and a fourth color, said fourth scent being different from said first, second and third scents and said fourth color being different from said first, second and third colors, and
optionally a fifth distinct fuel member which has a fifth scent and a fifth color, said fifth scent being different from said first, second, third and fourth scents and said fifth color being different from said first, second, third and fourth colors, and
wherein preferably the outer fuel portion of the solidified block of fuel has a scent which is different from said third scent and, if present, from said fourth and fifth scents.

5. The candle according to claim 1, wherein one or more of the distinct fuel members have a through-hole and are strung through said through-holes on the wick.

6. The candle according to claim 1, wherein at least two or more of the distinct fuel members are secured to the wick, preferably such that adjacent faces of adjacent distinct fuel members are spaced apart.

7. The candle according to claim 1, wherein the total amount of fragrance materials in the outer fuel portion and in each distinct fuel member is in the range of from 0.1 to 20% by weight, based on the total weight of the outer fuel portion or the respective fuel member.

8. The candle according to claim 1, wherein each distinct fuel member comprises one or more waxes having a melting point in the range of from 45 to 80° C. in a total amount in the range of from 60 to 98% by weight, based on the total weight of the respective fuel member.

9. The candle according to claim 1, wherein the outer fuel portion comprises one or more waxes having a melting point in the range of from 45 to 80° C. in a total amount in the range of from 60 to 98% by weight, based on the total weight of the outer fuel portion.

10. The candle according to claim 1, wherein the outer fuel portion and each distinct fuel member contain as main fuel component one or more waxes selected from the group consisting of paraffin wax, stearin wax, microcrystalline wax, carnauba wax, beeswax, palm wax, soy wax, spermaceti wax, ozokerite wax and mixtures thereof.

11. The candle according to claim 1, wherein each distinct fuel member contains an additive selected from the group consisting of ethyl vinyl acetate, petrolatum, polyethylene waxes, poly(α-olefins), fatty acids and mixtures thereof, in the range of from 0.5 to 20% by weight, based on the total weight of the respective fuel member.

12. The candle according to claim 1, wherein the outer fuel portion contains an additive selected from the group consisting of ethyl vinyl acetate, petrolatum, polyethylene waxes, poly(α-olefins), fatty acids and mixtures thereof, in the range of from 0.5 to 20% by weight, based on the total weight of the outer fuel portion.

13. The candle according to claim 1, wherein the outer fuel portion and each of the distinct fuel members contain the same fuel(s).

14. The candle according to claim 1, wherein the outer fuel portion in the solid state conceals the three dimensional shape of at least one of said distinct fuel members, wherein
the outer fuel portion and said at least one of said distinct fuel members are adapted to each other such that during burning of the candle a molten pool is formed by the outer fuel portion above said distinct fuel member such that the three dimensional shape of said distinct fuel member is exposed.

15. The candle according to claim 1, wherein the melting temperature of the outer fuel portion is lower than the melting temperature of the fuel of each of the distinct fuel members.

16. The candle according to claim 1, wherein on the outer surface of the candle essentially the scent of the outer fuel portion is perceived,
and optionally one more of the colors of the distinct fuel member(s) are visually perceivable on the surface of the candle.

17. The candle according to claim 1, wherein the thickness of the outer fuel portion on all sides of the distinct fuel members is at least 2 mm.

18. The candle according to claim 1, wherein in any part of the candle the shortest distance between the distinct fuel members and the outer surface of the outer fuel portion is at least 2 mm.

19. The candle according to claim 1, wherein the total amount of colorants in each distinct fuel member is in the range of from 0.001 to 0.5% by weight, based on the total weight of the respective fuel member.

20. The candle according to claim 1, wherein the distinct fuel members are fully embedded by the outer fuel portion by casting said outer fuel portion.

21. The candle according to claim 1, wherein the candle is a pillar candle or a container candle.

22. A process for manufacturing a candle comprising:
(a) providing
a wick,
two more distinct fuel members, wherein a first member and a second member of said distinct fuel members have different scents and different colors, and an outer fuel portion in liquefied or molten state,
(b) stringing said distinct fuel members on the wick such that a first member and a second member of said distinct fuel members are adjacent,
(c) placing the distinct fuel members strung on the wick into a mold or a container,
(d) casting said outer fuel portion, at a temperature in the range of from 5 to 30° C., above the melting temperature of said outer fuel portion, such that the outer fuel portion partially embeds the two more distinct fuel members strung on the wick,
(e) solidifying of the outer fuel portion in the mold or container, and
(f) removing the candle from the mold, if a mold was used.

23. The process according to claim 22, wherein the distinct fuel members strung on the wick in step (c) are arranged in the mold or container such that the shortest distance between the distinct fuel members and the outer surface of the outer fuel portion is at least 2 mm.

24. A candle or obtained according to a process of claim 22.

25. (canceled)

26. A process for conveying a multi-color and multi-scent experience, comprising the following steps:
burning a candle according to claim 1,
such that a pool of molten fuel of the outer fuel portion forms across the whole cross-section of the candle.
